(19) United States
(12) Patent Application Publication
(10) Pub. No.: US 2018/0162744 A1
(43) Pub. Date: Jun. 14, 2018

(54) MICRO-CLUSTER WATER DISTILLER AND WATER CLUSTER REFINER

(71) Applicant: SHANGHAI ARIBA ELECTRIC CO., LTD., Shanghai (CN)

(72) Inventor: LONG-MING WANG, Shanghai (CN)

(73) Assignee: SHANGHAI ARIBA ELECTRIC CO., LTD., Shanghai (CN)

(21) Appl. No.: 15/571,731

(22) PCT Filed: May 5, 2015
(86) PCT No.: PCT/CN2015/078285

§ 371 Date: Feb. 7, 2018

(51) Int. Cl. C02F 1/04; C02F 1/48

(52) U.S. Cl. CPC C02F 1/04; C02F 1/48

(57) ABSTRACT

A micro-cluster water distiller and a water cluster refiner thereof are used to solve the problem where the currently available water distillers cannot refine the water clusters. The micro-cluster water distiller includes a body having a water outlet; a hot water tank disposed in the body and configured to receive and heat water to produce vapor; a cooling module disposed in the body and including a condensing tube and a water outlet tube, with a head end of the condensing tube intercommunicating with a top of the hot water tank, with a terminal end of the condensing tube intercommunicating with a head end of the water outlet tube, with a terminal end of the water outlet tube intercommunicating with the water outlet; and a water cluster refiner including a permanent magnet disposed on the water outlet tube, with the permanent magnet having a magnetic field of 3000-5000 Gs.

### TECHNICAL FIELD

The present invention relates to a drinking water supply device and, more particularly, to a micro-cluster water distiller which can refine the water clusters of the distilled water.

### TECHNICAL BACKGROUND

A water molecule consists of an oxygen atom and two hydrogen atoms. However, a water molecule cannot exist alone because the water molecules form hydrogen bonds therebetween, linking the water molecules to each other and forming a cluster of water molecules. Approximately, general tap water consists of more than 14 water molecules.

### DISCLOSURE TO THE INVENTION

### Technical Problem

Regarding the examination method of the water clusters, Nuclear Magnetic Resonance (NMR) is currently used to examine the resonant frequency of the water, so as to obtain the quantity of the water molecules in a water cluster. Namely, the higher the resonant frequency the larger the water cluster, and the quantity of the water molecules is larger, and the quality of the water is lower. For example, the resonant frequencies of the well water, rainwater, river water and tap water (about the size of 10-15 water molecules) are higher than 100 Hz (about 120-140 Hz). The resonant frequency of high quality mineral water (about the size of 8-9 water molecules) is about 90 Hz. The resonant frequency of the water from the longevity village of Okinawa, Japan is about 85 Hz.

Furthermore, the researches show that the water molecules of the water cluster can be refined by applying an external power to break the hydrogen bonds of the water cluster to thereby cut the bonding force among the water molecules of the water cluster, such that the water molecules are rearranged to form a well-arranged, high-density water cluster, which contains about 5-9 water molecules, and is called “micro-cluster water.” The micro-cluster water has a resonant frequency of smaller than 90 Hz.

The micro-cluster water has a great penetration to cell tissues and can easily pass in and out of the tiny gaps between the dense proteins (or called “water channels,” which have a width of about 2 μm). It is thus easily absorbed by human body to facilitate the metabolism. Besides, the micro-cluster water is alkalescent, which can effectively control the acidification of the human body and maintain the health of the body.

On the other hand, to improve the convenience in drinking water, in the modern time various water distillers are available in indoor environments such as houses, offices, governmental organizations and exhibition rooms, and even in outdoor environments such as schools and parks. However, the conventional water distillers as disclosed in China, Taiwan Patent Nos. 424554 entitled “Water Distiller,” 533903 “Improvement to the Structure of the Water Distiller,” M378929 “Concentrated Solar Power Water Distiller,” M463100 “Improved Structure of a Water Distiller” cannot refine the water molecules. Thus, it is not easy for us to drink the micro-cluster distilled water that has a good taste and is healthy. What a regret it is!

In light of this, it is necessary to improve the conventional water distillers.

### Solutions to the Technical Problem

### Technical Solutions

The invention provides a micro-cluster water distiller which can refine the water clusters of the distiller water to provide micro-cluster distilled water to users for drinking purposes.

The invention provides a water cluster refiner to be easily installed in a water distiller, such that the water distiller can provide micro-cluster distilled water to users for drinking purposes.

The micro-cluster water distiller according to the invention includes a body having a water outlet; a hot water tank disposed in the body and configured to receive and heat water to produce vapor; a cooling module disposed in the body and including a condensing tube and a water outlet tube, with a head end of the condensing tube intercommunicating with a top of the hot water tank, with a terminal end of the condensing tube intercommunicating with a head end of the water outlet tube, with a terminal end of the water outlet tube intercommunicating with the water outlet; and a water cluster refiner including a permanent magnet disposed on the water outlet tube, with the permanent magnet having a magnetic field of 3000-5000 Gs.

In an example, the strength of the magnetic field of the permanent magnet is 4000±10% Gs.

In the example, the permanent magnet can be mounted to an outer periphery of the water outlet tube.

In the example, the magnetic pole face of the permanent magnet can be abutted with and secured to the outer wall of the water outlet tube.

In the example, the outer wall of the water outlet tube can include a plane, and the magnetic pole face of the permanent magnet abuts with the plane.

In the example, the water cluster refiner can include a magnetically insulating member enclosing the permanent magnet, and a magnetic pole face of the permanent magnet is exposed to abut with the water outlet tube.

In the example, the water cluster refiner can include a housing enclosing the magnetically insulating member.

In the example, a rustproof layer can be disposed between the magnetically insulating member and the housing.

In the example, the rustproof layer can be formed on an outer face of the magnetically insulating member or on an inner face of the housing.

In the example, the water cluster refiner includes at least one fixing member, and the fixing member abuts with the housing to tightly bind the water outlet tube with the permanent magnet, the magnetically insulating member and the housing.

In the example, the water cluster refiner includes another permanent magnet, and the two permanent magnets are mounted at two diametrically opposite sides of the water outlet tube and face each other with different magnetic poles.

In the example, a surface of the permanent magnet that is used to abut with the water outlet tube is in an arched form.

In the example, the water cluster refiner can further include another permanent magnet, and the two permanent magnets are disposed on the outer wall of the water outlet tube and are spaced from each other.

In the example, a water outlet valve can be mounted to the water outlet of the body, a terminal end of the water outlet tube is connected to the water outlet valve, a pump is mounted on the water outlet tube and is electrically connected to the water outlet valve, and the water cluster refiner can be disposed between the head end of the water outlet tube and the pump.

In the example, the body can include a water supply tank intercommunicating with the hot water tank via a tube, and the water cluster refiner includes another permanent magnet mounted on the tube connected to the water supply tank.

In the example, the water cluster refiner includes another permanent magnet that can be mounted on the terminal end of the condensing tube.

A water cluster refiner according to the invention includes a permanent magnet having a magnetic field of 3000-5000 Gs; a magnetically insulating member enclosing the permanent magnet, with a magnetic pole face of the permanent magnet being exposed; and a housing enclosing the magnetically insulating member, wherein, a rustproof layer is disposed between the magnetically insulating member and the housing.

In an example, the magnetic field of the permanent magnet is 4000±10% Gs.

In the example, the rustproof layer is formed on an outer face of the magnetically insulating member or on an inner face of the housing.

The water cluster refiner can further include a fixing member abutting with the housing to tightly bind the permanent magnet, the magnetically insulating member and the housing with a tube.

Based on this, the micro-cluster water distiller according to the invention can, with the provision of the permanent magnet of the water cluster refiner mounted to the outer periphery of the water outlet tube, the magnetism of the permanent magnet refines the water clusters of the distilled water that passes through the water outlet tube. Based on this, even though the raw water comes from a water source where the water clusters have larger sizes, the user can conveniently drink the micro-cluster distilled water via the micro-cluster water distiller, which helps to maintain the body health. Furthermore, the water cluster refiner according to the invention can be conveniently installed in a currently-available water distiller such that the water distiller can provide micro-cluster distilled water to users for drinking purposes.

### BRIEF DESCRIPTION OF THE DRAWINGS

### The Description of the Drawings

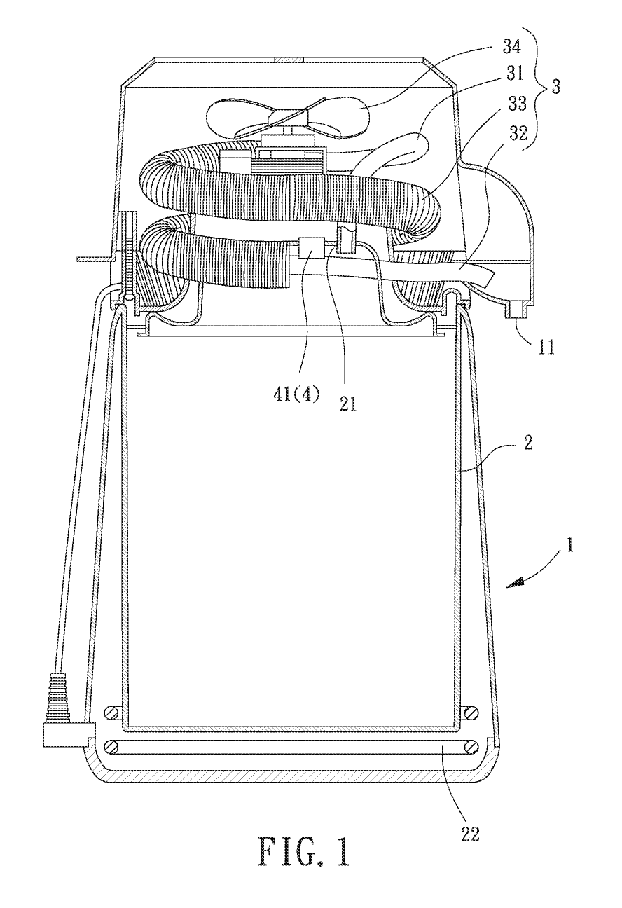

FIG. 1 is a diagrammatic cross-sectional view of an embodiment of the invention.

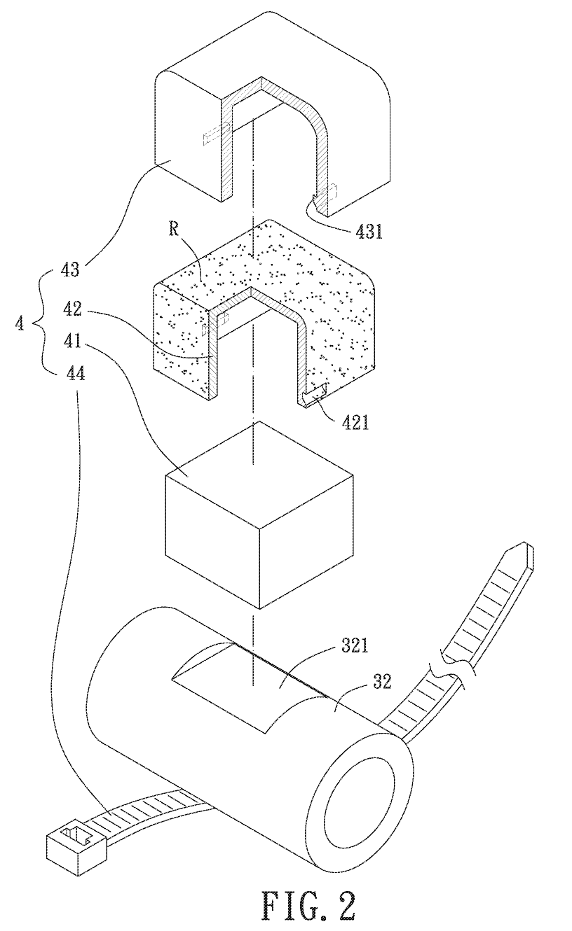

FIG. 2 is a diagrammatic three-dimensional structural diagram of a water cluster refiner of a first embodiment of the invention.

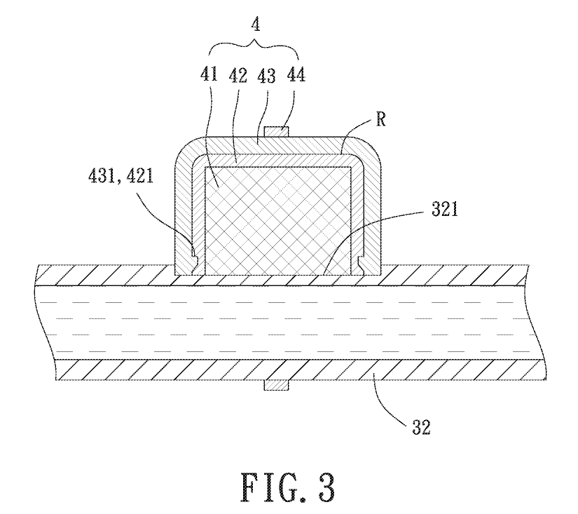

FIG. 3 is a diagrammatic implementation diagram of the water cluster refiner of the first embodiment of the invention.

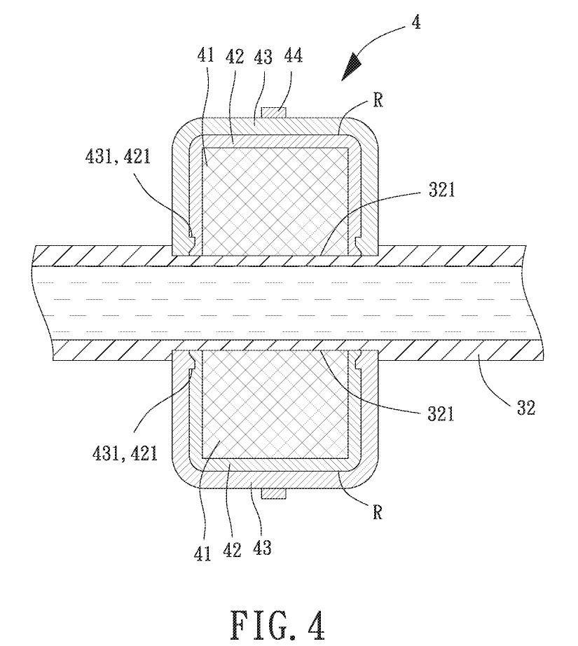

FIG. 4 is a diagrammatic implementation diagram of a water cluster refiner of a second embodiment of the invention.

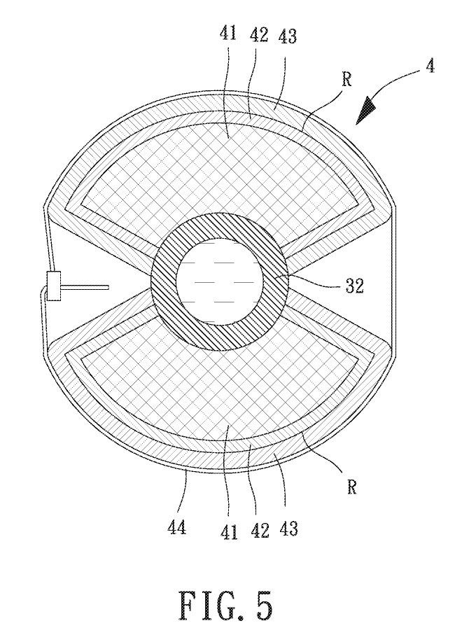

FIG. 5 is a diagrammatic implementation diagram of a water cluster refiner of a third embodiment of the invention.

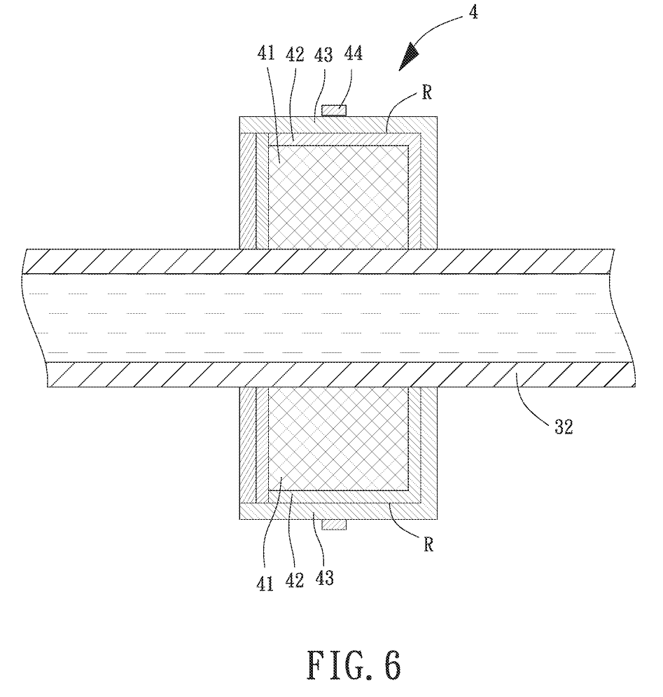

FIG. 6 is a diagrammatic implementation diagram of the water cluster refiner of the third embodiment of the invention taken from another observation angle.

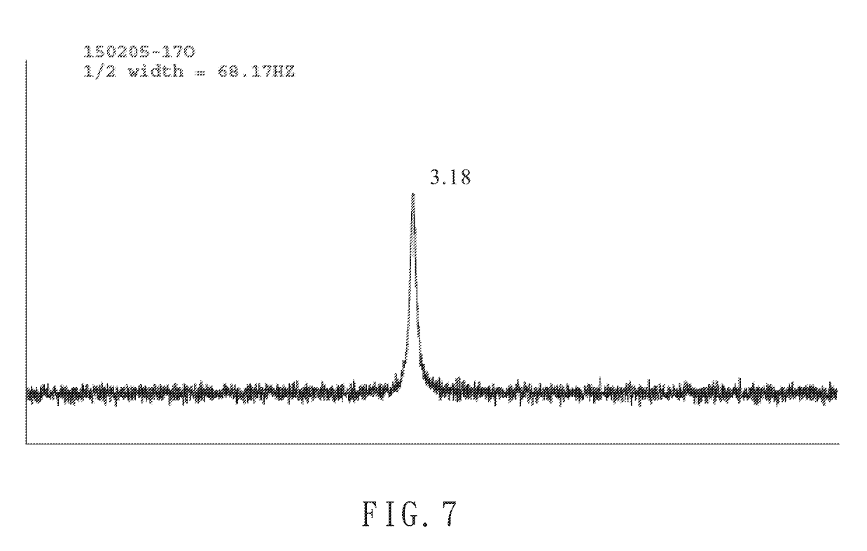

FIG. 7 is a diagram of an examination result of a resonant frequency of the micro-cluster distilled water obtained from the invention.

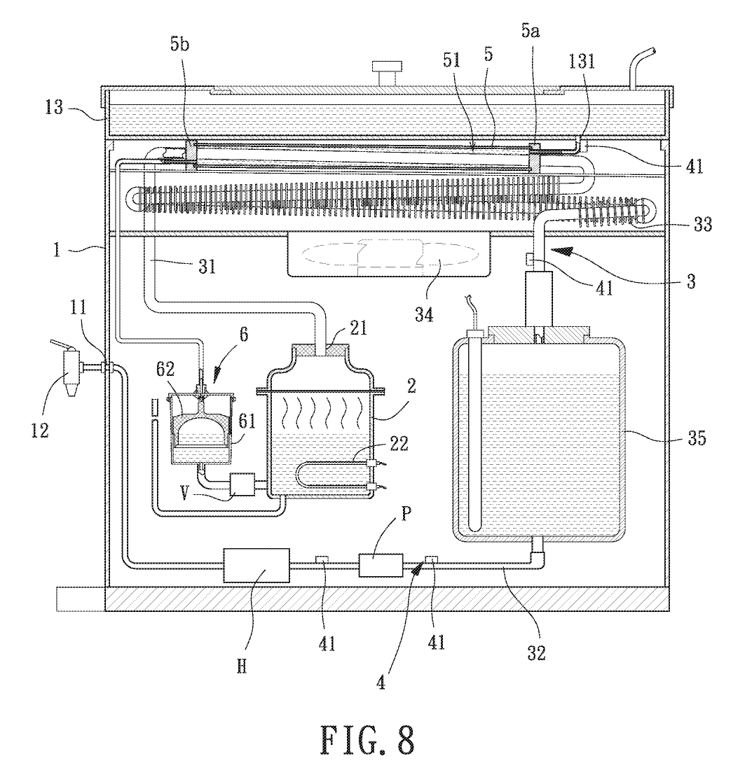

FIG. 8 is a diagrammatic cross-sectional view of another embodiment of the invention.

[Description of the element numbers of primary elements]

| 1 body | 11 water outlet |
|---|---|
| 12 water outlet valve | 13 water supply tank |
| 131 water supply inlet | |
| 2 hot water tank | 21 vapor outlet |
| 22 heating member | |
| 3 cooling module | 31 condensing tube |
| 32 water outlet tube | 321 plane |
| 33 cooling member | 34 wind-driving member |
| 35 water collecting tank | |
| 4 water cluster refiner | 41 permanent magnet |
| 42 magnetically insulating member | 421 positioning portion |
| 43 housing | 431 positioning portion |
| 44 fixing member | |
| 5 heat exchange tube | 5a water inlet end |
| 5b water outlet end | 51 heat exchange room |
| 6 water level control unit | 61 tank |
| 62 stopper member | |
| H heating member | P pump |
| R rustproof layer | V valve |

### THE BEST EMBODIMENT IN CARRYING OUT THE INVENTION

### The Best Embodiment of the Invention

For easy understanding of the above or other purposes, characteristics and advantages of the invention, preferred embodiments according to the invention are described in detail below in connection with the accompanying drawing.

Please refer to FIG. 1 which shows a micro-cluster water distiller of an embodiment according to the invention. The micro-cluster water distiller substantially includes a body 1, a hot water tank 2, a cooling module 3 and a water cluster refiner 4. The hot water tank 2, the cooling module 3 and the water cluster refiner 4 are disposed in the body 1.

The body 1 is not limited to any shape in so far as it can accommodate other major parts of the micro-cluster water distiller. In this embodiment, the body 1 is substantially in the form of a pot and includes a water outlet 11.

The hot water tank 2 is disposed in the body 1 and is used to receive and heat the water into vapor. In this embodiment, the hot water tank 2 includes a vapor outlet 21 on a top thereof. A heating member 22 is annularly around an outer periphery of a bottom of the hot water tank 2. The heating member 22 heats the water to a boiling state and the produced vapor can exit the hot water tank 2 via the vapor outlet 21.

The cooling module 3 is disposed in the body 1 and can be any element capable of condensing the vapor. In this embodiment, the cooling module 3 includes a condensing tube 31, a water outlet tube 32, a cooling member 33 and a wind-driving member 34. A head end of the condensing tube 31 intercommunicates with the vapor outlet 21 on the top of the hot water tank 2, permitting the vapor in the hot water tank 2 to be input to the condensing tube 31. A terminal end of the condensing tube 31 intercommunicates with a head end of the water outlet tube 32, such that the liquid-state distilled water is input to the water outlet tube 32. A terminal end of the water outlet tube 32 intercommunicates with the water outlet 11 of the body 1. The condensing tube 31 and the water outlet tube 32 are connected to each other, such as integral connection, mutual fitting, or indirect connection via a fitting. This permits the distilled water obtained from the condensation to directly exit the water outlet 11 through the water outlet tube 32. Alternatively, a water collecting tank (not shown) can be disposed between the condensing tube 31 and the water outlet tube 32. This permits the distilled water obtained from the condensation to be temporarily stored in the water collecting tank. The distilled water flows out through the water outlet tube 32 and the water outlet 11 for the drinking purposes as necessary.

The cooling member 33 is fit around an outer periphery of the condensing tube 31 to assist in cooling the condensing tube 31 and to increases the condensing efficiency of the vapor. The cooling member 33 can be a plurality of cooling fins, for example. In addition, the cooling fins are preferably spaced from each other when disposed on the outer periphery of the condensing tube 31, improving the cooling effect. The wind-driving member 34 can be a fan which can rotate upon power up and which rapidly draws the external cool air, decreasing the temperature of the condensing tube 31 and the cooling member 33.

The water cluster refiner 4 at least includes a permanent magnet 41. The permanent magnet 41 is mounted to the water outlet tube 32 in order for the distilled water that passes the water outlet tube 32 to be magnetized by the magnetism of the permanent magnet 41, thereby refining the waster cluster. The permanent magnet 41 has a magnetic field of 3000-5000 Gs, which is preferably about 4000 Gs. Wherein, the permanent magnet 41 can be fixed in the water outlet tube 32 or optionally fixed to the outer periphery of the water outlet tube 32. When the permanent magnet 41 is fixed to the outer periphery of the water outlet tube 32, the permanent magnet 41 is more adjacent to the water outlet tube 32 and the magnetization effect of the distilled water in the water outlet tube 32 is better. Therefore, a magnetic pole face of the permanent magnet 41 of the water cluster refiner 4 (any one of N pole and S pole) abuts with the outer wall of the water outlet tube 32. It is particularly noted that the permanent magnet 41 should be mounted to a part of the water outlet tube 32 where the temperature is below 60° C. (more preferably below the room temperature) in order not to reduce the magnetism of the permanent magnet 41. Therefore, in an embodiment where a heating member is further mounted to the water outlet tube 32, it should be avoided that the permanent magnet 41 is placed too close to the heating member.

In addition to the basic function where the permanent magnet 41 is used to magnetize the distilled water, the water cluster refiner 4 can further include some components according to requirements in order to improve the safety in use and the convenience in assembly of the water cluster refiner 4, as discussed in some embodiments below.

Please refer to FIGS. 2 and 3, in a first embodiment of the water cluster refiner 4, the permanent magnet 41 of the water cluster refiner 4 is substantially in the form of a cube. To improve the coupling stability between the permanent magnet 41 and the water outlet tube 32, the outer wall of the water outlet tube 32 can include a plane 321 with which the magnetic pole face of the permanent magnet 41 abuts.

Since the invention uses a permanent magnet 41 having a very high magnetic-field strength, the water cluster refiner 4 preferably further includes a magnetically insulating member 42 that encloses the permanent magnet 41. A magnetic pole face of the permanent magnet 41 is exposed to abut with the water outlet tube 32, preventing the magnetism of the permanent magnet 41 from exposure. This avoids a magnetically-attracted object from attaching to the body 1 as attracted by the permanent magnet 41 and avoids difficult detachment of the object from the body 1. This even avoids an impact to the life safety of the user having an implant such as a cardiac pacemaker. The magnetically insulating member 42 can be a metal material such as low-carbon steel.

Moreover, the water cluster refiner 4 can further include a housing 43 enclosing the magnetically insulating member 42. The housing 43 has a buffering function so that the permanent magnet 41 and the magnetically insulating member 42 are not easily damaged when experiencing an external force. In this embodiment, the magnetically insulating member 42 and the housing 43 can respectively include positioning portions 421, 431 for mutual engagement. In this embodiment, a rustproof layer R is preferably disposed between the magnetically insulating member 42 and the housing 43, such that the rustproof layer R prevents the permanent magnet 41 and the magnetically insulating member 42 from rusting after they are used for a period of time. In order to simply the structure and to improve the convenience in assembly, the rustproof layer R can be formed by ways of such as paint coating or electroplating (such as nickel plating).

The ways to couple the permanent magnet 41, the magnetically insulating member 42 and the housing 43 with the water outlet tube 32 are not limited. For example, the permanent magnet 41, the magnetically insulating member 42 and the housing 43 can be adhered to the outer wall of the water outlet tube 32 by adhesion. Alternatively, the water cluster refiner 4 can include at least one fixing member 44. The fixing member 44 abuts with the housing 43 to bind the water outlet tube 32 with the permanent magnet 41, the magnetically insulating member 42 and the housing 43, thus effectively preventing the disengagement of the permanent magnet 41, the magnetically insulating member 42 and the housing 43 from the water outlet tube 32 resulting from vibration.

Please refer to FIG. 4. In a second embodiment of the water cluster refiner 4, the water cluster refiner 4 includes two sets of permanent magnets 41, magnetically insulating members 42 and housings 43. In this embodiment, each set of the permanent magnets 41, the magnetically insulating members 42 and the housings 43 is similar to the first embodiment above, and therefore is not redundantly described herein again. It is noted that when the two permanent magnets 41 are mounted at two diametrically opposite sides of the water outlet tube 32, the two permanent magnets 41 should face each other with different magnetic poles to improve the magnetization effect of the distilled water. Furthermore, the water cluster refiner 4 in this embodiment also includes at least one fixing member 44. The fixing member 44 tightly binds the two housings 43 around the outer peripheries thereof, ensuring that each of the two sets of the permanent magnets 41, the magnetically insulating members 42 and the housings 43 can securely couple with the water outlet tube 32.

Please refer to FIGS. 5 and 6. In a third embodiment of the water cluster refiner 4, the water cluster refiner 4 also includes two sets of permanent magnets 41, magnetically insulating members 42 and housings 43. The water cluster refiner 4 mainly differs from the second embodiment in that the surface of each permanent magnet 41 that is used to abut with the water outlet tube 32 is in an arched form, so as to increase the areas that the two permanent magnets 41 cover the outer wall of the water outlet tube 32. This permits the magnetization effect of the distilled water to be further improved. Since the shape of the permanent magnet 41 cannot be directly fit and enveloped by the magnetically insulating member 42 and the housing 43 in a radial direction of the water outlet tube 32, the magnetically insulating member 42 and the housing 43 in this embodiment can have openings arranged at the lateral ends to permit the magnetically insulating member 42 and the housing 43 to fit and envelop in an axial direction of the water outlet tube 32, and the openings are then closed. Alternatively, the permanent magnets 41 can be in an annular form to directly fit the permanent magnets 41 around the outer wall of the water outlet tube 32.

It is worth mentioning that when the water cluster refiner 4 includes two or more permanent magnets 41, the plural permanent magnets 41 do not necessarily have to be diametrically disposed in pairs. They may be disposed along the outer wall of the water outlet tube 32 in intervals, magnetizing the distilled water in sections. This is particularly useful in an embodiment where the water outlet tube 32 has more bends.

Please refer to FIG. 1 again. Based on the above structure, during the operation of the micro-cluster water distiller according to the invention, after the hot water tank 2 heats the water to produce vapor, the vapor can enter the condensing tube 31 via the vapor outlet 21 and cools down and condenses into pure and drinkable distilled water. The drinkable distilled water flows into the water outlet tube 32, and the water clusters thereof are refined by the magnetization of the permanent magnet 41 when passing through the water cluster refiner 4 mounted to the outer periphery of the water outlet tube 32. As a result, the micro-cluster distilled water flows out of the water outlet 11 of the body 1 for the user's drinking.

Please refer to FIG. 7. The micro-cluster distilled water as produced by the micro-cluster water distiller has an absorption peak at a chemical shift of 3.18 ppm as examined by the nuclear magnetic resonance spectrometer manufactured by Bruker Corporation, a German company. Therefore, it can be presumed that its resonant frequency (the frequency of the absorption peak) is 68.17 Hz. It is smaller than 90 Hz, satisfying the definition of “micro-cluster water.”

Please refer to FIG. 8 which is another embodiment of the micro-cluster water distiller according to the invention. In addition to a body 1, a hot water tank 2, a cooling module 3 and a water cluster refiner 4, the micro-cluster water distiller further includes a heat exchange tube 5 and a water level control unit 6, as elaborated below.

The body 1 in this embodiment has a larger volume. A water outlet 11 is disposed on a front side of the body 1 for assembly of a water outlet valve 12. The body 1 includes a water supply tank 13 on a top of the interior of the body 1, as so to accommodate a large amount of raw water. The water supply tank 13 includes a water supply inlet 131 on a bottom thereof, which supplies water to the hot water tank 2 via the connection of a tube.

The heat exchange tube 5 includes two ends being a water inlet end 5a and a water outlet end 5b, respectively. The interior of the heat exchange tube 5 includes a heat exchange room 51. A tube is disposed between the water supply inlet 131 of the water supply tank 13 and the water inlet end 5a of the heat exchange tube 5 to intercommunicate the water supply tank 13 with the heat exchange room 51 of the heat exchange tube 5. This permits the water to flow from the water supply tank 13 to the heat exchange tube 5.

The water level control unit 6 includes a tank 61 and a stopper member 62. A top of the tank 61 intercommunicates with the water outlet end 5b of the heat exchange tube 5 via a tube, permitting the water in the heat exchange tube 5 to flow into the tank 61. The stopper member 62 is disposed in the tank 61 and has a density smaller than a density of the water in the tank 61.

The hot water tank 2 intercommunicates with a bottom of the tank 61 of the water level control unit 6 to permit the water in the tank 61 to flow into the hot water tank 2. The tube between the tank 61 and the hot water tank 2 is mounted with a valve V. The hot water tank 2 includes a vapor outlet 21 on a top thereof. A heating member 22 is mounted on a bottom of the interior of the heating member 22, such that the heating member 22 heats the water to a boiling state. The produced vapor can exit the hot water tank 2 via the vapor outlet 21.

The cooling module 3 includes a condensing tube 31, a water outlet tube 32, a cooling member 33 and a wind-driving member 34. A head end of the condensing tube 31 intercommunicates with the vapor outlet 21 on the top of the hot water tank 2, permitting the vapor in the hot water tank 2 to be input to the condensing tube 31. The condensing tube 31 extends through the heat exchange tube 5, such that the vapor that is input to the condensing tube 31 can exchange heat with the relatively low temperature water in the heat exchange tube 5 in this section, increasing the condensation efficiency of the vapor. The cooling member 33 is fit around a part of the outer periphery of the condensing tube 31 that extends out of the heat exchange tube 5, and the wind-driving member 34 that is mounted in the body 1 blows the external cool air to the condensing tube 31 and the cooling member 33 to rapidly condense the vapor in the condensing tube 31 into liquid droplets.

A terminal end of the condensing tube 31 intercommunicates with a head end of the water outlet tube 32, so as to deliver the distilled water that is condensed into the liquid state to the water outlet tube 32. A terminal end of the water outlet tube 32 is connected to the water outlet valve 12 of the body 1. In this embodiment, a water collecting tank 35 is further disposed between the condensing tube 31 and the water outlet tube 32. This makes the distilled water that is obtained from the condensation to be temporarily stored in the water collecting tank 35, which flows out of the water outlet valve 12 through the water outlet tube 32 for the drinking purposes as necessary.

Besides, in this embodiment, a pump P and a heating member H can be further mounted on the water outlet tube 32. This pump P is electrically connected to the water outlet valve 12, and the heating member H is disposed between the water outlet valve 12 and the pump P. Based on this, when the user intends to drink the lukewarm distilled water, the heating member H can be activated, so that the distilled water flows out of the water outlet valve 12 after heating by the heating member H.

Based on the same technique concept as the aforementioned embodiments, the water cluster refiner 4 is also mounted to the outer periphery of the water outlet tube 32 in this embodiment. The water cluster refiner 4 at least includes a permanent magnet 41. The magnetism of the permanent magnet 41 magnetizes the distilled water that passes the water outlet tube 32, thus refining the water clusters thereof. Thus, all the liquid that flows towards the water outlet valve 12 is micro-cluster distilled water.

It is needed to address that since the pump P makes the liquid flow faster, therefore it is preferred that the water cluster refiner 4 is disposed between the head end of the water outlet tube 32 and the pump P. This makes the water to be sufficiently refined before flowing out of the water outlet tube 32 under pressure. Besides, as is shown in the figure of the embodiment, the water cluster refiner 4 can include two or more permanent magnets 41. At least one permanent magnet 41 should be disposed between the head end of the water outlet tube 32 and the pump P. The location of the other permanent magnet 41 is not particularly limited, but it is cautioned that it should not be too close to the heating member H in order to avoid the part of the water outlet tube 32, that has a higher temperature (above 60° C.), from affecting the function of the permanent magnet 41.

Besides, one of the permanent magnets 41 may be disposed on a tube connected between the water supply tank 13 and the heat exchange tube 5. This permits the raw water that exits the water supply tank 13 to be magnetized by the permanent magnet 41, thus causing a change to the molecular structure of the mineral components (such as CaCO3, MgCO3, etc.) in the water. Therefore, after the water flows into the heat exchange tube 5, the tank 61 and the hot water tank 2, the mineral components do not easily adhere or accumulate to each other. Thus, accumulation of scales on the tube wall or the tank wall does not occur easily. Particularly, in the hot water tank 2, the mineral components in the water can become softer substances (such as Ca(HCO3)², Mg(HCO3)², etc.) during the boiling process. This can avoid that more energy is consumed for boiling the water due to the scale accumulation in the hot water tank 2, achieving power-saving and scale-cleaning functions.

Furthermore, this embodiment may further have one of the permanent magnets 41 disposed on the terminal end of the condensing tube 31. This refines the water clusters of the distilled water before flowing into the water collecting tank 35 for temporary storage, and the permanent magnet 41 that is disposed between the head terminal of the water outlet tube 32 and the pump P refines the water clusters of the distilled water again after the distilled water exits the water collecting tank 35. This ensures that the water clusters of the distilled water that finally exits the water outlet valve 12 can be sufficiently refined to obtain the high-quality micro-cluster distilled water.

In summary of the above, the micro-cluster water distiller according to the invention can, with the provision of the water cluster refiner 4 that includes the permanent magnets mounted to the outer periphery of the water outlet tube, use the magnetism of the permanent magnets to refine the water clusters of the distilled water that passes the water outlet tube. Based on this, even though the raw water comes from a water source where the water clusters have larger sizes, the user can conveniently drink the micro-cluster distilled water via the micro-cluster water distiller, maintaining the body health.

The water cluster refiner according to the invention can be conveniently installed in a currently available water distiller to permit the water distiller to provide micro-cluster distilled water for the user's drinking.

What is claimed is:

1. A micro-cluster water distiller, characterized in, comprising:
a body having a water outlet;
a hot water tank disposed in the body and configured to receive and heat water to produce vapor;
a cooling module disposed in the body and including a condensing tube and a water outlet tube, with a head end of the condensing tube intercommunicating with a top of the hot water tank, with a terminal end of the condensing tube intercommunicating with a head end of the water outlet tube, with a terminal end of the water outlet tube intercommunicating with the water outlet; and
a water cluster refiner including a permanent magnet disposed on the water outlet tube, with the permanent magnet having a magnetic field of 3000-5000 Gs.

2. The micro-cluster water distiller as claimed in claim 1, characterized in that the magnetic field of the permanent magnet is 4000±10% Gs.

3. The micro-cluster water distiller as claimed in claim 1 or 2, characterized in that the permanent magnet is mounted to an outer periphery of the water outlet tube.

4. The micro-cluster water distiller as claimed in claim 3, characterized in that the permanent magnet abuts with and is fixed to the outer wall of the water outlet tube.

5. The micro-cluster water distiller as claimed in claim 4, characterized in that the outer wall of the water outlet tube includes a plane, with a magnetic pole face of the permanent magnet abutting with the plane.

6. The micro-cluster water distiller as claimed in claim 4, characterized in that the water cluster refiner includes a magnetically insulating member enclosing the permanent magnet, and a magnetic pole face of the permanent magnet is exposed to abut with the water outlet tube.

7. The micro-cluster water distiller as claimed in claim 6, characterized in that the water cluster refiner includes a housing enclosing the magnetically insulating member.

8. The micro-cluster water distiller as claimed in claim 7, characterized in that a rustproof layer is disposed between the magnetically insulating member and the housing.

9. The micro-cluster water distiller as claimed in claim 8, characterized in that the rustproof layer is formed on an outer face of the magnetically insulating member or an inner face of the housing.

10. The micro-cluster water distiller as claimed in claim 7, characterized in that the water cluster refiner includes at least one fixing member, the fixing member abuts with the housing to tightly bind the water outlet tube with the permanent magnet, the magnetically insulating member and the housing.

11. The micro-cluster water distiller as claimed in claim 4, characterized in that the water cluster refiner includes another permanent magnet, the two permanent magnets are mounted at two diametrically opposite sides of the water outlet tube and face each other with different magnetic poles.

12. The micro-cluster water distiller as claimed in claim 4, characterized in that a surface of the permanent magnet that is used to abut with the water outlet tube is in an arched form.

13. The micro-cluster water distiller as claimed in claim 4, characterized in that the water cluster refiner further includes another permanent magnet, the two permanent magnets are disposed on the outer wall of the water outlet tube and are spaced from each other.

14. The micro-cluster water distiller as claimed in claim 4, characterized in that a water outlet valve is mounted to the water outlet of the body, a terminal end of the water outlet tube is connected to the water outlet valve, a pump is mounted on the water outlet tube and is electrically connected to the water outlet valve, the water cluster refiner is disposed between the head end of the water outlet tube and the pump.

15. The micro-cluster water distiller as claimed in claim 4, characterized in that the body includes a water supply tank intercommunicating with the hot water tank via a tube, the water cluster refiner includes another permanent magnet mounted on the tube of the water supply tank.

16. The micro-cluster water distiller as claimed in claim 4, characterized in that the water cluster refiner includes another permanent magnet mounted on the terminal end of the condensing tube.

17. A water cluster refiner, characterized in, comprising:
a permanent magnet having a magnetic field of 3000-5000 Gs;
a magnetically insulating member enclosing the permanent magnet, with a magnetic pole face of the permanent magnet being exposed; and
a housing enclosing the magnetically insulating member;
wherein, a rustproof layer is disposed between the magnetically insulating member and the housing.

18. The water cluster refiner as claimed in claim 17, characterized in that the magnetic field of the permanent magnet is 4000±10% Gs.

19. The water cluster refiner as claimed in claim 17 or 18, characterized in that the rustproof layer is formed on an outer face of the magnetically insulating member or an inner face of the housing.

20. The water cluster refiner as claimed in claim 17 or 18, characterized in that: further includes a fixing member abutting with the housing to tightly bind a tube with the permanent magnet, the magnetically insulating member and the housing.
